(19) United States
(12) Patent Application Publication
(10) Pub. No.: US 2026/0127441 A1
(43) Pub. Date: May 7, 2026

(54) DATA GENERATION METHOD, MODEL TRAINING METHOD, AND DATA PROCESSING METHOD

(71) Applicant: BEIJING BAIDU NETCOM SCIENCE TECHNOLOGY CO., LTD., Beijing (CN)

(72) Inventors: Jianhua WANG, Beijing (CN); Zhifan FENG, Beijing (CN); Hua WU, Beijing (CN); Xing YUAN, Beijing (CN); Dou HONG, Beijing (CN)

(21) Appl. No.: 19/425,129

(22) Filed: Dec. 18, 2025

(30) Foreign Application Priority Data
Jun. 12, 2025 (CN) 202510788012.3

(51) Int. Cl. G06N 3/09

(52) U.S. Cl. CPC G06N 3/09

(57) ABSTRACT

A data generation method, a model training method, a data processing method, an electronic device, and a storage medium are provided, which relate to the field of artificial intelligence technologies, and in particular to the fields of large model and intelligent agent technologies. The data generation method includes: generating at least one response result to be evaluated using at least one of data synthesis expert units; determining at least one evaluation result for the at least one response result to be evaluated using at least one of the data synthesis expert units; in response to determining that the at least one evaluation result indicates a presence of at least one response result to be corrected, determining at least one correction data according to at least one evaluation result for the at least one response result to be corrected; and returning to the generating step.

### CROSS-REFERENCE TO RELATED APPLICATION(S)

This application claims the benefit of Chinese Patent Application No. 202510788012.3 filed on Jun. 12, 2025, the whole disclosure of which is incorporated herein by reference.

### TECHNICAL FIELD

The present disclosure relates to the field of artificial intelligence technologies, and in particular to the fields of large model and intelligent agent technologies. More specifically, the present disclosure provides a data generation method, a model training method, a data processing method, an electronic device, and a storage medium.

### BACKGROUND

Sample data serves as the foundation for training large language models. With the rapid development of large language models (LLMs), the demand for large-scale and high-quality sample data continues to increase during the training of large models, in order to continuously enhance the capabilities of large models.

### SUMMARY

The present disclosure provides a data generation method, a model training method, a data processing method, an electronic device, and a storage medium.

According to an aspect of the present disclosure, a data generation method is provided, including: generating at least one response result to be evaluated using at least one of a plurality of data synthesis expert units; determining at least one evaluation result for the at least one response result to be evaluated using at least one of the plurality of data synthesis expert units; in response to determining that the at least one evaluation result indicates a presence of at least one response result to be corrected among the at least one response result to be evaluated, determining at least one correction data for at least one data synthesis expert unit according to at least one evaluation result for the at least one response result to be corrected; and returning a process to generating at least one response result to be evaluated using at least one of the plurality of data synthesis expert units until the at least one evaluation result indicates an absence of any response result to be corrected among the at least one response result to be evaluated, where the data synthesis expert unit is configured to generate a response result to be evaluated according to at least one of target data and received correction data.

According to another aspect of the present disclosure, a model training method is provided, including: inputting target data in a sample data pair into a model to be trained, to obtain a response result to be optimized; and training the model to be trained according to the response result to be optimized and a target response result in the sample data pair, where the sample data pair is determined by: generating at least one response result to be evaluated using at least one of a plurality of data synthesis expert units, where the data synthesis expert unit is configured to generate a response result to be evaluated according to the target data; determining at least one evaluation result for the at least one response result to be evaluated using at least one of the plurality of data synthesis expert units; and in response to determining that the at least one evaluation result indicates an absence of any response result to be corrected among the at least one response result to be evaluated, determining the sample data pair according to the target data and a target response result among the at least one response result to be evaluated.

According to another aspect of the present disclosure, a data processing method is provided, including: inputting data to be processed into a target model to obtain a response result corresponding to the data to be processed, where the target model is obtained by training a model to be trained according to the method described in embodiments of the present disclosure.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the methods provided in the present disclosure.

According to another aspect of the present disclosure, a non-transitory computer-readable storage medium storing computer instructions is provided, where the computer instructions are configured to, when executed by a computer, cause the computer to perform the methods provided in the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 shows a schematic diagram of an exemplary system architecture to which a data generation method and apparatus, a model training method and apparatus, and a data processing method and apparatus may be applied according to an embodiment of the present disclosure;

FIG. 2 shows a flowchart of a data generation method according to an embodiment of the present disclosure;

FIG. 3A shows a schematic diagram of a data generation method according to an embodiment of the present disclosure;

FIG. 3B shows a schematic diagram of data synthesis according to an embodiment of the present disclosure;

FIG. 4 shows a flowchart of a data generation method according to another embodiment of the present disclosure;

FIG. 5 shows a flowchart of a model training method according to an embodiment of the present disclosure;

FIG. 6 shows a flowchart of a data processing method according to an embodiment of the present disclosure;

FIG. 7 shows a block diagram of a data generation apparatus according to an embodiment of the present disclosure;

FIG. 8 shows a block diagram of a model training apparatus according to an embodiment of the present disclosure;

FIG. 9 shows a block diagram of a data processing apparatus according to an embodiment of the present disclosure; and

FIG. 10 shows a block diagram of an electronic device to which the data generation method, the model training method, and the data processing method may be applied according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

At present, data synthesis technologies for large models mainly include four methods as follows.

A first method involves generating sample pairs of instructions and response results using large models. Training large models with such sample pairs may reduce manual annotation costs but is prone to causing incorrect cognition of large models.

A second method involves replacing manual annotation with feedback from artificial intelligence large models to achieve automatic alignment between instructions and response results. However, this method relies on strong teacher models, and the reliability of the feedback on the response results is not high.

A third method involves introducing artificially generated adversarial samples during model training to improve model stability and prevent erroneous responses of models caused by interference factors. However, this method lacks sufficient diversity in the generated data, and the artificially generated adversarial samples may deviate from real-world scenarios.

A fourth method involves applying knowledge distillation to transfer the capability of a large model to a small model, thereby improving the robustness and generation capability of the small model. However, this method depends heavily on the generation quality of the teacher model and may introduce incorrect knowledge from the teacher model. In addition, the data generated by the teacher model lack diversity, and the student model exhibits limited generalization capability.

The above four methods all suffer from issues such as insufficient diversity of generated data, poor quality of response results, weak generalization capability, and unbalanced distribution of generated data.

In view of the above, the present disclosure proposes a data generation method, a model training method, and a data processing method, which aim to achieve efficient, accurate, and diversified large-model data generation through collaborative operation of multiple expert large models.

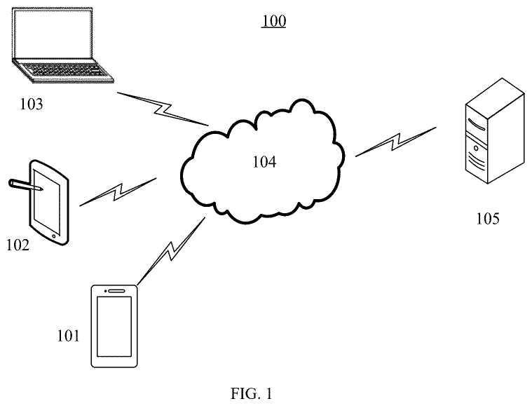

FIG. 1 shows a schematic diagram of an exemplary system architecture to which a data generation method and apparatus, a model training method and apparatus, and a data processing method and apparatus may be applied according to an embodiment of the present disclosure. It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to this embodiment may include terminal devices 101, 102, and 103, a network 104, and a server 105. The network 104 serves as a medium for providing a communication link between the terminal devices 101, 102, 103 and the server 105. The network 104 may include various types of connections, such as wired and/or wireless communication links.

The terminal devices 101, 102, and 103 may be used by a user to interact with the server 105 through the network 104 to receive or send messages, etc. The terminal devices 101, 102, and 103 may be various electronic devices having display screens and supporting web browsing, including but not limited to smart phones, tablet computers, laptop computers, and desktop computers, etc.

The server 105 may be a server that provides various services, such as a background management server (merely as an example) that supports websites browsed by the user through the terminal devices 101, 102, and 103. The background management server may analyze and process received user requests and data to be processed, and feed processing results (for example, processing results generated according to user input information) back to the terminal devices. The server 105 may be deployed with a trained predetermined model, obtain a final response result by inputting user input information into the predetermined model, and return the response result to the user. The predetermined model may be a large language model (LLM).

It should be noted that the data generation method, the model training method, and the data processing method provided by embodiments of the present disclosure may generally be performed by the server 105. Accordingly, the data generation apparatus, the model training apparatus, and the data processing apparatus provided by embodiments of the present disclosure may generally be disposed in the server 105. The data generation method, the model training method, and the data processing method provided by embodiments of the present disclosure may also be performed by the terminal devices 101, 102, 103. Accordingly, the data generation apparatus, the model training apparatus, and the data processing apparatus provided by embodiments of the present disclosure may also be disposed in the terminal devices 101, 102, 103. The data generation method, the model training method, and the data processing method provided by embodiments of the present disclosure may also be performed by a server or server cluster different from the server 105 and capable of communicating with the terminal devices 101, 102, 103 and/or the server 105. Accordingly, the data generation apparatus, the model training apparatus, and the data processing apparatus provided by embodiments of the present disclosure may also be disposed in a server or server cluster different from the server 105 and capable of communicating with the terminal devices 101, 102, 103 and/or the server 105.

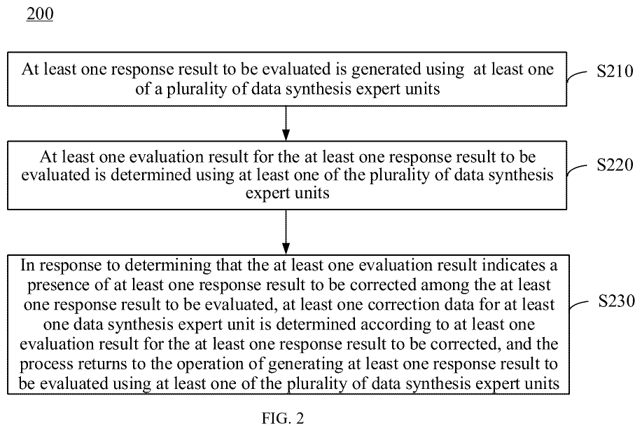

FIG. 2 shows a flowchart of a data generation method according to an embodiment of the present disclosure.

As shown in FIG. 2, a data generation method 200 may include operation S210 to operation S230.

In operation S210, at least one response result to be evaluated is generated using at least one of a plurality of data synthesis expert units.

The data synthesis expert unit may refer to a large model obtained by learning data features in a specific domain. The plurality of data synthesis expert units may refer to large models that focus on different domains or tasks and determine response results through different solution strategies. The response result to be evaluated may refer to a response result generated by a data synthesis expert unit upon receiving data such as input text.

For example, an input text may be input into three data synthesis expert units to obtain three different response results related to the input text, which are used as response results to be evaluated.

In operation S220, at least one evaluation result for the at least one response result to be evaluated is determined using at least one of the plurality of data synthesis expert units.

The generated response result to be evaluated may be evaluated using a single data synthesis expert unit, or a plurality of data synthesis expert units may be selected to perform evaluation, thereby obtaining an evaluation result from multiple dimensions.

For example, one or more of the three data synthesis expert units may be used to evaluate the three generated response results to be evaluated. The data synthesis expert units may evaluate the response results to be evaluated from different evaluation perspectives such as data diversity or rationality, thereby obtaining corresponding evaluation results.

The evaluation result may indicate whether the response result to be evaluated meets generation requirements.

For example, the three data synthesis expert units may include a first data synthesis expert unit, a second data synthesis expert unit, and a third data synthesis expert unit. The second data synthesis expert unit may evaluate the response results to be evaluated from the perspective of rationality. If the evaluation result generated by the second data synthesis expert unit indicates that the response result conforms to common sense, it may be determined that the response result to be evaluated is correct. If the evaluation result generated by the second data synthesis expert unit indicates that the response result does not conform to common sense, it may be determined that the response result to be evaluated contains an error.

In operation S230, in response to determining that the at least one evaluation result indicates a presence of at least one response result to be corrected among the at least one response result to be evaluated, at least one correction data for at least one data synthesis expert unit is determined according to at least one evaluation result for the at least one response result to be corrected, and the process returns to the operation of generating at least one response result to be evaluated using at least one of the plurality of data synthesis expert units, until the at least one evaluation result indicates an absence of any response result to be corrected among the at least one response result to be evaluated.

The response result to be corrected may refer to an erroneous response result that fails to meet the generation requirements. The correction data may be an optimized text for the response result to be corrected, which is used to correct errors occurring in the understanding and reasoning processes of the data synthesis expert unit.

In embodiments of the present disclosure, it may be determined, according to the evaluation result generated by the data synthesis expert unit, whether the at least one response result to be evaluated meets the generation requirements. A response result that fails to meet the generation requirements is determined as a response result to be corrected. Correction data for optimization may be generated according to the response result to be corrected and may be input into the corresponding data synthesis expert unit, so that the data synthesis expert unit performs adjustment and optimization based on the correction data to generate data that complies with requirements.

For example, the second data synthesis expert unit may evaluate a plurality of response results to be evaluated from the perspective of rationality. Suppose the plurality of response results to be evaluated includes a first response result to be evaluated and a second response result to be evaluated. If the evaluation result for the first response result to be evaluated indicates that the first response result to be evaluated does not conform to common sense, correction data may be generated for the first response result to be evaluated, so that the corresponding correction data may be input into the first data synthesis expert unit that generated the first response result to be evaluated.

In embodiments of the present disclosure, the data synthesis expert unit is configured to generate a response result to be evaluated according to at least one of target data and received correction data.

The target data may refer to text information input into a data synthesis expert unit for generating a response result, and the target data may be a material text for generating a response result. Based on the target data and the correction data generated in operation S230, the process may return to operation S210 to regenerate a response result. Subsequently, the processing flow from operation S210 to operation S230 may be repeated, where the target data and the correction data generated based on the evaluation result are jointly input into the data synthesis expert unit to enable multiple cyclic iterations of the data synthesis expert unit, until the response result generated by the data synthesis expert unit based on the target data in a subsequent iteration meets the requirements, that is, until the evaluation result provided by the data synthesis expert unit indicates an absence of any response result to be corrected among the response results to be evaluated.

According to embodiments of the present disclosure, diverse response results may be generated through the collaborative operation of the plurality of expert units, and the response results may be adjusted and optimized through the evaluation, reflection and correction processes, thereby achieving a rapid iteration of response results. The generated response results may be used as training data for large models, providing high-quality and accurate training data for subsequent fine-tuning of large models.

In embodiments of the present disclosure, the data synthesis expert unit may be a data synthesis large model or a data synthesis agent.

By training and optimizing a model through pre-training, supervised fine-tuning (SFT), or direct preference optimization (DPO), large models or agents specialized in different domains may be obtained to generate response results according to input text.

In embodiments of the present disclosure, the target data may be material data for generating response results, including multiple types of data. The target data may include at least one of target text data, target audio data, target image data, and target video data.

For example, the target data may be target text data such as news, novels, or article materials. The target data may also be target audio data such as songs, instrumental music, or sound effects. The target data may also be target image data such as photographs, emojis, or animated images. The target data may also be target video data such as animations, recordings, or films and television programs.

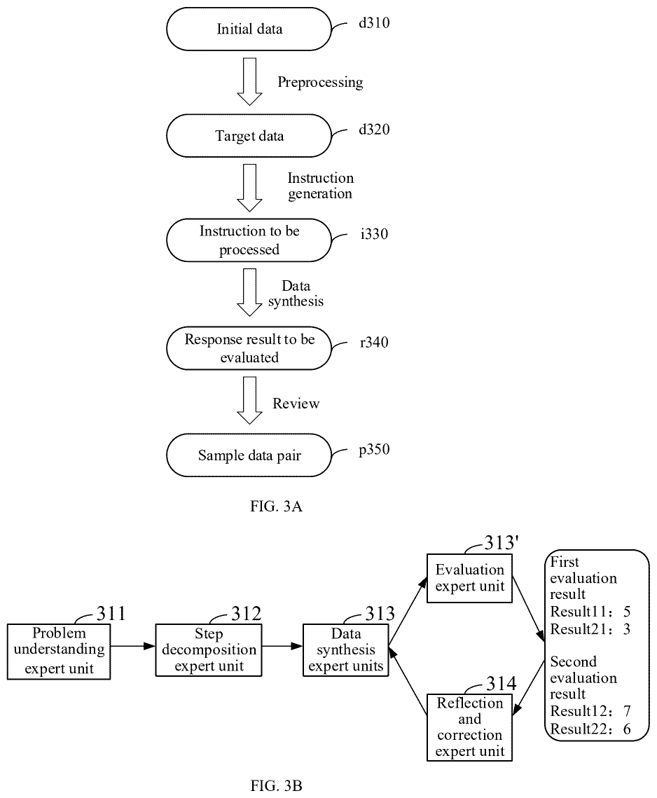

The data generation method of the present disclosure is now further described with reference to FIG. 3A.

FIG. 3A shows a schematic diagram of a data generation method according to an embodiment of the present disclosure.

As shown in FIG. 3A, in embodiments of the present disclosure, a plurality of initial data d310 may be preprocessed to obtain at least one target data d320. The preprocessing may include filtering and labeling, which will be described below.

In embodiments of the present disclosure, the preprocessing process may include: filtering the plurality of initial data d310 according to a preset filtering rule to obtain at least one intermediate data; and labeling the at least one intermediate data to obtain at least one target data d320.

The preset filtering rule may refer to a rule for filtering out data irrelevant to the generation task as well as low-quality data lacking practical significance. The low-quality data may include data that are semantically contradictory.

The preprocessing process may be used to filter out low-quality data through the preset filtering rule, thereby preventing data that do not comply with the preset filtering rule from entering subsequent processing stages. Meanwhile, data that comply with the preset filtering rule may be labeled to obtain target data having at least one label, so that the target data may be provided to a large model or agent corresponding to the label.

The label may indicate a source, content, format, or expression style of the target data.

For example, the initial data may include a paragraph describing the moon. By preprocessing the initial data, target data containing labels may be obtained. The labels contained in the target data may include: a domain label of “literature”, a language type label of “Chinese”, and a source label of “a certain magazine”.

According to embodiments of the present disclosure, through the filtering, labeling and other preprocessing of the target data such as input corpora and questions, meaningless or irrelevant data may be prevented from entering subsequent processes. In subsequent data synthesis and processing stages, a clear representation corresponding to the target data may be obtained through the labels, thereby improving the rationality, accuracy, and diversity of data synthesis.

Subsequently, an instruction to be processed i330 may be determined based on the target data.

For example, when the target data is a paragraph describing the moon, the instruction to be processed determined based on the target data may be “generate an image about the moon” or “generate a poem about the moon”. Based on the target data, different instructions to be processed with different generation difficulties, expression styles, languages, or data volumes may be determined, thereby improving the diversity of data synthesis.

In embodiments of the present disclosure, the data synthesis expert unit may generate a response result to be evaluated according to at least one selected from: the at least one label, the target data, and the received correction data.

When the data synthesis expert unit generates a response result to be evaluated based on the target data for the first time, the generation may be performed based solely on the label or the target data.

In a first synthesis process within a data synthesis process that allows multiple iterations, upon receiving the target data d320, the at least one label, and the instruction to be processed i330, the data synthesis expert unit may generate a response result to be evaluated r340 corresponding to the instruction to be processed i330 according to the target data d320 and the at least one label.

After the response result to be evaluated has been evaluated and the corresponding correction data has been generated, the data synthesis expert unit may, upon receiving the correction data, generate a corresponding response result to be evaluated r340 according to the target data d320 and at least one selected from the at least one label, the instruction to be processed i330, and the correction data. Then, the response result to be evaluated r340 may be reviewed in terms of quality, format, compliance, etc. Upon successful review, a sample data pair p350 is determined. The data synthesis process is described below with reference to FIG. 3B.

FIG. 3B shows a schematic diagram of data synthesis according to an embodiment of the present disclosure.

As shown in FIG. 3B, a plurality of expert large models may respectively serve as a problem understanding expert unit 311, a step decomposition expert unit 312, a plurality of data synthesis expert units 313, an evaluation expert unit 313′, and a reflection and correction expert unit 314. The evaluation expert unit 313′ may evaluate a response result to be evaluated. One or more of the plurality of expert large models serving as the plurality of data synthesis expert units 313 may be used as one or more evaluation expert units 313′.

In embodiments of the present disclosure, in some implementations of operation S210, generating at least one response result to be evaluated using at least one of the plurality of data synthesis expert units includes: generating at least one response result to be evaluated using at least one of the plurality of data synthesis expert units based on at least one sub-problem to be processed determined from a data understanding result.

The data understanding result is obtained according to at least one of the target data and the instruction to be processed, and the instruction to be processed is obtained according to the target data. The instruction to be processed may be text including one or more characters. By way of example, when the data understanding result is obtained according to both the target data and the instruction to be processed, the problem understanding expert unit may be used to understand the instruction to be processed so as to determine the data understanding result. The data understanding result may be a result obtained by understanding information such as the context, generation conditions, and requirements of the input instruction to be processed. It may be understood that for different instructions to be processed, different solution paths may be adopted to determine different problem understanding results, so as to generate a response result to be evaluated via an appropriate path.

For example, when the target data is a paragraph describing the moon, the instruction to be processed determined according to the target data may be “generate a poem about the moon”. The data understanding result generated by the problem understanding expert unit 311 according to the target data and the instruction to be processed may be “generate a seven-character quatrain praising the moon in conjunction with the target data”.

It may be understood that the above description has explained the data understanding of the present disclosure. A step decomposition based on the data understanding result will be described below.

According to embodiments of the present disclosure, generating at least one response result to be evaluated using at least one of the plurality of data synthesis expert units based on at least one sub-problem to be processed determined from the data understanding result includes: determining at least one sub-problem to be processed using the step decomposition expert unit 312 according to the data understanding result; and generating at least one response result to be evaluated using at least one of the plurality of data synthesis expert units based on the at least one sub-problem to be processed.

The sub-problem to be processed may be obtained by understanding and analyzing the instruction to be processed and the data understanding result and decomposing an originally complex instruction to be processed into a plurality of sub-problems that are easier for a data synthesis expert unit to understand. The data synthesis expert unit may solve the instruction to be processed according to the decomposed steps or sub-problems, thereby obtaining a response result to be evaluated.

For example, as described above, when the target data is a paragraph describing the moon, the instruction to be processed generated according to the target data may be “generate a poem about the moon”, and the data understanding result determined according to the instruction to be processed and the target data may be “generate a seven-character quatrain praising the moon in conjunction with the target data”. According to the data understanding result, the instruction to be processed may be decomposed into a plurality of sub-problems to be processed, including “extract words about the moon from the target data”, “obtain the poetic format”, “determine wording according to the metrical rules of seven-character quatrains”, and “generate a poem about the moon”. One or more data synthesis expert units may sequentially solve the plurality of sub-problems to be processed to obtain one or more corresponding response results to be evaluated.

It may be understood that the above description has explained the step decomposition and data synthesis methods of the present disclosure. A further description of the evaluation expert unit will be provided below.

According to embodiments of the present disclosure, in some implementations of operation S220, determining at least one evaluation result for the at least one response result to be evaluated using at least one of the plurality of data synthesis expert units includes: determining N intermediate evaluation data for an intermediate result to be evaluated using N data synthesis expert units 313, where the intermediate result to be evaluated is obtained by masking an identification information in a response result to be evaluated, the identification information in the response result to be evaluated is associated with the data synthesis expert unit that generated the response result to be evaluated, and N is an integer greater than or equal to 1; and determining an evaluation result for the response result to be evaluated according to the N intermediate evaluation data for the intermediate result to be evaluated.

In embodiments of the present disclosure, a data synthesis expert unit may serve as an evaluation expert unit to perform a blind evaluation on the response result to be evaluated. The blind evaluation refers to a process in which, during evaluation of a response result to be evaluated, the data synthesis expert unit serving as the evaluation expert unit is unable to obtain any information associated with the data synthesis expert unit that generated the response result to be evaluated. By masking at least the identification information in the response result to be evaluated, a plurality of intermediate results to be evaluated with unknown sources may be obtained, so that data synthesis and evaluation may be performed using a reduced number of expert large models, thereby reducing the computational resource overhead required to obtain sample data.

For example, the first data synthesis expert unit, the second data synthesis expert unit, and the third data synthesis expert unit may respectively generate a first response result to be evaluated, a second response result to be evaluated, and a third response result to be evaluated. By masking the identification information in the response results to be evaluated, three intermediate results to be evaluated may be obtained. Two data synthesis expert units are randomly selected from the three data synthesis expert units to act as evaluation expert units, and each may evaluate the three intermediate results to be evaluated, thereby obtaining two intermediate evaluation data for each intermediate result to be evaluated. According to the two intermediate evaluation data for each intermediate result to be evaluated, an evaluation result for the corresponding response result to be evaluated may be determined.

According to embodiments of the present disclosure, the evaluation result may include at least one evaluation metric value, and the at least one evaluation metric value includes at least one of a first evaluation metric value and a second evaluation metric value.

The first evaluation metric value may be, for example, a metric value indicating a positive evaluation, such as a metric value for fluency of language or a metric value for rationality. The second evaluation metric value may be a metric value indicating a negative evaluation, such as a metric value for contradiction degree or a metric value for redundancy degree. For example, in the two intermediate evaluation data for each intermediate result to be evaluated, each intermediate evaluation data may include a first intermediate evaluation value and a second intermediate evaluation value. An average value of the two first intermediate evaluation values respectively from the two intermediate evaluation data may be determined as a first evaluation metric value. An average value of the two second intermediate evaluation values respectively from the two intermediate evaluation data may be determined as a second evaluation metric value.

It may be understood that the above description has explained the evaluation expert unit of the present disclosure. Some methods for determining the correction data will be described below.

In some embodiments, the above-described method may further include: in response to determining that a plurality of evaluation metric values for a response result to be evaluated fail to meet one or more of at least one preset evaluation conditions, determining the response result to be evaluated as a response result to be corrected. The at least one preset evaluation condition includes at least one selected from: the first evaluation metric value is greater than or equal to a first evaluation threshold; and the second evaluation metric value is less than or equal to a second evaluation threshold.

For example, as shown in FIG. 3B, the first evaluation threshold may be preset to 6, and the second evaluation threshold may be preset to 5. The first evaluation result for the first response result to be evaluated includes a first evaluation metric value Result11 and a second evaluation metric value Result21, where the first evaluation metric value Result11 is 5, and the second evaluation metric value Result21 is 3. It may be determined that the first response result to be evaluated fails to meet the preset evaluation condition, and thus the first response result to be evaluated is determined to be a first response result to be corrected. The second evaluation result for the second response result to be evaluated includes a first evaluation metric value Result12 and a second evaluation metric value Result22, where the first evaluation metric value Result12 is 7, and the second evaluation metric value Result22 is 6. It may be determined that the second response result to be evaluated fails to meet the preset evaluation condition, and thus the second response result to be evaluated is determined to be a second response result to be corrected. Accordingly, the at least one evaluation result indicates a presence of at least one response result to be corrected among the plurality of response results to be evaluated. Operation S230 described above may then be performed.

In some embodiments, in some implementations of operation S230, in response to determining that the at least one evaluation result indicates the presence of at least one response result to be corrected among the at least one response result to be evaluated, at least one correction data for at least one data synthesis expert unit may be determined using the reflection and correction expert unit 314 according to at least one evaluation result for the at least one response result to be corrected. For example, first correction data for the first data synthesis expert unit may be determined using the reflection and correction expert unit 314 according to the first evaluation result for the first response result to be corrected. Thus, by using the evaluation expert unit to perform blind evaluation on a response result of a model from multiple perspectives and perform quantitative analysis of the response result using various evaluation metrics, it may be determined whether the response result meets the requirements. If the response result fails to meet the requirements, correction data may be promptly generated and fed back, which may ensure the quality of the ultimately generated data and achieve accurate and diversified data synthesis.

Subsequently, the process may return to operation S210 until at least one subsequently determined evaluation result indicates an absence of any response result to be corrected among the at least one response result to be evaluated. When correction data is present, the data synthesis expert unit may regenerate a response result by combining the correction data with the target data and one or more labels.

For example, the correction data may be correction text. The correction text for the first data synthesis expert may be “the moon in the poem should appear at night”. The correction text is provided to the data synthesis expert unit, so that the data synthesis expert unit regenerates a subsequent response result to be evaluated.

According to embodiments of the present disclosure, through reflection and analysis of diverse response results generated by the expert models, errors in the generated results may be promptly identified. Correction data may then be generated for the errors and fed back to the expert models, thereby adjusting and optimizing the synthesis strategies of the expert models and facilitating iterative improvement of the expert models.

It may be understood that the presence of a response result to be corrected among one or more response results to be evaluated is illustrated above by way of example to describe the present disclosure. After multiple rounds of data generation and correction, the one or more response results to be evaluated may all meet the above preset evaluation condition, such that no response result to be corrected is present. This process is now described below.

In some embodiments, the above-described method further includes: in response to determining that the at least one evaluation result indicates an absence of any response result to be corrected among the at least one response result to be evaluated, determining a sample data pair according to the target data and a target response result among the at least one response result to be evaluated.

The target response result may be determined from the at least one response result to be evaluated. The target response result may refer to a highest-quality response result among the response results that meet the preset evaluation condition. Selection of the target response result may involve multidimensional comparison in terms of diversity, data length, language style, generation professionalism, etc., so as to determine the target response result from the one or more response results to be evaluated. The target response result and the target data input into the data synthesis expert unit may then form a sample data pair for model training.

For example, as described above, according to the target data (text describing the moon), three response results to be evaluated may be generated by three data synthesis expert units. If the evaluation results for the three response results to be evaluated all meet the preset evaluation condition, it may be determined that the three evaluation results indicate an absence of any response result to be corrected among the three response results to be evaluated. The three response results to be evaluated may then be ranked in multiple dimensions, and one of the response results to be evaluated may ultimately be determined as the target response result. The target response result and the target data may form a sample data pair. In an example, the ranking may be performed in descending order of the first evaluation metric value, such that the response result to be evaluated with the highest first evaluation metric value is selected as the target response result. It may be understood that other ranking methods may also be employed.

It may be understood that the above description illustrates an example in which the target data and the target response result from a sample data pair to explain the present disclosure. However, the present disclosure is not limited thereto, which will be described below.

In some embodiments, the instruction to be processed and the target response result may form a sample data pair. For example, the instruction to be processed “generate a poem about the moon” and the above-described target response result may form a sample data pair.

It may be understood that the above description illustrates an example in which the sample data pair is determined according to the target response result and at least one of the target data and the instruction to be processed to explain the present disclosure. However, the present disclosure is not limited thereto, and a further evaluation may be performed on the target response result, which will be described below.

According to embodiments of the present disclosure, determining the sample data pair according to the target data and the target response result among the at least one response result to be evaluated includes: determining the sample data pair in response to determining that the target response result meets at least one preset data generation condition. The sample data pair includes the target response result and at least one of the target data and the instruction to be processed obtained from the target data. The at least one preset data generation condition includes that a data format of the target response result is a preset data format.

In embodiments of the present disclosure, a quality audit expert unit may perform multidimensional quality review and evaluation on the target response result generated by the data synthesis expert unit. For example, the data format of the target response result may be reviewed from the dimension of data format.

In embodiments of the present disclosure, the at least one preset data generation condition may further include that: a content quality of the target response result meets a preset data quality condition; and the target response result complies with a preset data rule. The preset data rule may include relevant laws and regulations or public order and good customs.

For example, if the target response result is a segment of code, the content quality of the target response result may refer to attribute data such as a processing speed and time complexity of the code. The preset data quality condition may specify that the time complexity of the target response result is less than a preset complexity threshold. If it is determined that the time complexity of the target response result meets the preset data generation condition, the target response result together with the corresponding target data and/or instruction to be processed may be used as a sample data pair.

According to embodiments of the present disclosure, by using the quality audit expert unit to perform multidimensional review on the response result generated by the expert large model, the quality of the ultimately generated data may be ensured, thereby obtaining high-quality sample data.

It may be understood that the above description illustrates an example in which an instruction to be processed is generated according to the target data to explain the present disclosure. However, the present disclosure is not limited thereto. The following description illustrates an example in which problem understanding is performed according to the target data.

In other embodiments, the data understanding result may be obtained using the problem understanding expert unit 311 according to the target data.

For example, when the target data is a paragraph describing the moon, the problem understanding expert unit 311 may determine the data understanding result as “generate a poem in Chinese having the form of a quatrain, with content related to the target data” according to the target data. For another example, when problem understanding is performed according to the target data, the problem understanding result may also be “generate an image of the moon in a cartoon style, with reference to the target data”.

It may be understood that the method of the present disclosure has been described above. A further description of the method of the present disclosure is provided below in the context of a code generation scenario.

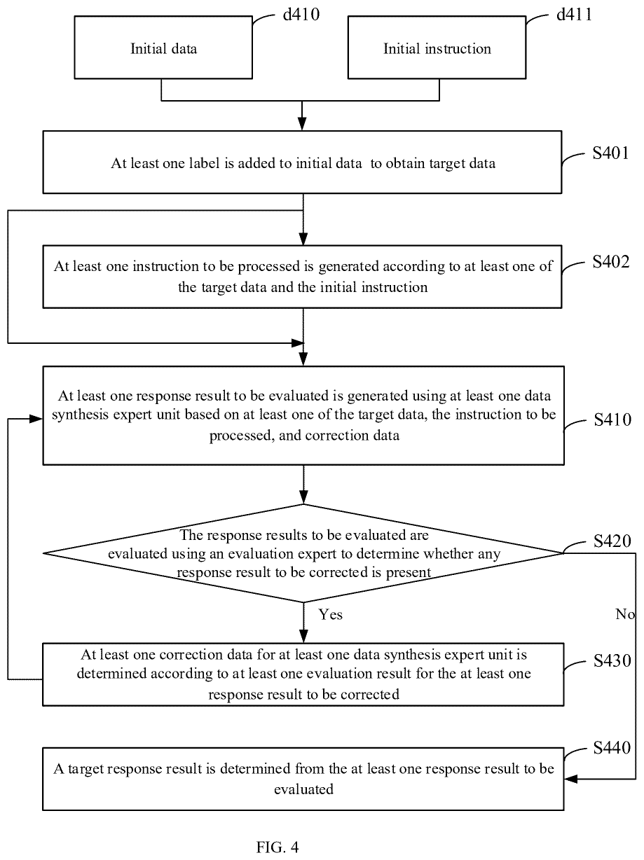

FIG. 4 shows a flowchart of a data generation method according to another embodiment of the present disclosure.

As shown in FIG. 4, the data generation method includes operations S401 to S402 and operations S410 to S440.

In operation S401, a plurality of initial data are preprocessed to obtain at least one target data.

For example, a large amount of open-source code may be acquired as a plurality of initial data d410. The initial data may include a segment of open-source code. By preprocessing the initial data, target data containing labels may be obtained. The labels contained in the target data may include: a text type label of “code”, a domain label of “finance”, a function label of “SQL query”, a language type label of “Python”, and a source label of “open-source code repository”. For another example, a user-input instruction provided to a large model in a code generation scenario may be acquired as an initial instruction d411. Subsequently, operation S402 may be performed.

In operation S402, at least one instruction to be processed is generated according to at least one of the target data and the initial instruction. For example, if the target data is a segment of code, different instructions to be processed may include “explain the code”, “modify the code”, “add comments to the code”, etc.

In operation S410, at least one response result to be evaluated is generated using at least one data synthesis expert unit based on at least one of the target data, the instruction to be processed, and correction data.

In embodiments of the present disclosure, when data synthesis is performed for the first time, no correction data is provided for the data synthesis expert unit. In this case, the target data and the instruction to be processed may be input into a plurality of data synthesis expert units to obtain a plurality of response results to be evaluated.

For example, according to different instructions to be processed, a plurality of data synthesis expert units may provide diverse response results to be evaluated. The following description takes the instruction to be processed “add comments to the code” as an example.

In embodiments of the present disclosure, the target data and additional labels may be used as model inputs, with the additional labels serving as supplementary descriptions of the target data, so as to obtain corresponding response results to be evaluated.

For example, when the target data is a segment of open-source code having labels “finance”, “code”, and “Python”, the target data and additional labels “improve” and “add comments” may be input together into the data synthesis expert unit to obtain a plurality of response results to be evaluated.

In other embodiments of the present disclosure, after performing operation S401, operation S402 may optionally be omitted. Operation S410 may be performed based on the target data obtained in operation S401, such that at least one data synthesis expert unit generates the same number of response result to be evaluated according to the target data. For example, the target data may be a segment of code having labels “finance” and “Python”. When the target data is input into a plurality of data synthesis expert units, each data synthesis expert unit may process the target data from a different perspective, thereby obtaining response results to be evaluated such as modified code, corrected code, or rewritten code. The response results to be evaluated may include code-comment results. The following description will continue using the example in which operation S402 is performed.

In operation S420, the response results to be evaluated are evaluated using an evaluation expert to determine whether any response result to be corrected is present. If the at least one evaluation result indicates that the at least one response result to be evaluated includes a response result to be corrected, operation S430 is performed. If the at least one evaluation result indicates that the at least one response result to be evaluated does not include any response result to be corrected, operation S440 is performed.

In operation S430, at least one correction data for at least one data synthesis expert unit is determined according to at least one evaluation result for the at least one response result to be corrected.

In embodiments of the present disclosure, the reflection and correction expert unit may provide correction data corresponding to the response result to be corrected, based on the evaluation result. The data synthesis expert unit may generate a response result to be evaluated that better meets the preset evaluation condition, based on the correction data.

For example, when the target data is a segment of code, the response result to be evaluated determined by the data synthesis expert unit based on the target data may be a code-comment result. After obtaining the evaluation result for the response result to be evaluated, the reflection and correction expert may determine the correction data as “the target data is a code, not a sentence to be translated”. Based on the correction data and the target data, the data synthesis expert unit may regenerate a response result to be evaluated that better meets the preset evaluation condition.

After at least one correction data for at least one data synthesis expert unit is obtained, the process may return to operation S410. After one or more rounds of data generation based on the correction data, if the at least one evaluation result indicates that the at least one response result to be evaluated does not include any response result to be corrected, operation S440 may be performed.

In operation S440, a target response result is determined from the at least one response result to be evaluated.

According to embodiments of the present disclosure, by providing a plurality of instructions to be processed, the data synthesis expert units may generate response results from different perspectives and under different requirements, ensuring diversity of the response results. Moreover, through reflection and analysis of the generated response results followed by regeneration of data, high-quality and diverse training samples may be efficiently and accurately obtained through such a synthesis method, thereby facilitating iterative improvement of large models.

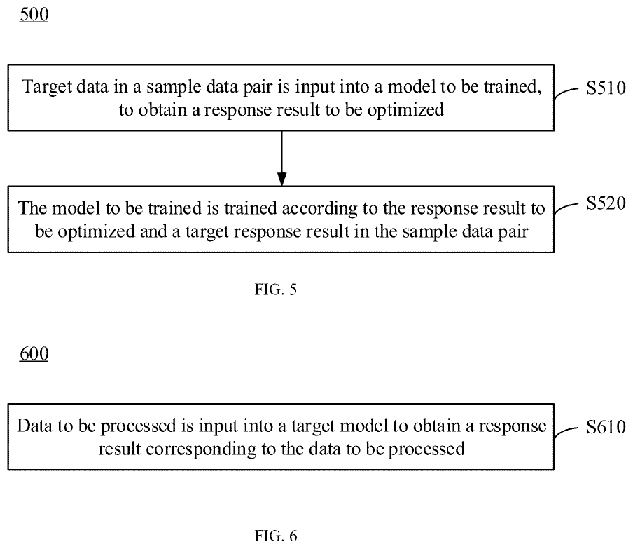

FIG. 5 shows a flowchart of a model training method according to an embodiment of the present disclosure.

As shown in FIG. 5, a model training method 500 includes operation S510 to operation S520.

In operation S510, target data in a sample data pair is input into a model to be trained, to obtain a response result to be optimized.

The response result to be optimized may be a response result generated by the model to be trained based on the target data.

In operation S520, the model to be trained is trained according to the response result to be optimized and a target response result in the sample data pair.

A loss between the target response result and the response result to be optimized may be calculated, and parameters of the model to be trained may be adjusted based on the loss until the loss between the target response result and the response result to be optimized is less than a preset loss threshold, thereby obtaining a trained target model.

In embodiments of the present disclosure, the sample data pair is determined as follows: at least one response result to be evaluated is generated using at least one of a plurality of data synthesis expert units, where the data synthesis expert unit is configured to generate a response result to be evaluated according to the target data; at least one evaluation result for the at least one response result to be evaluated is determined using at least one of the plurality of data synthesis expert units; in response to determining that the at least one evaluation result indicates an absence of any response result to be corrected among the at least one response result to be evaluated, the sample data pair is determined according to the target data and a target response result among the at least one response result to be evaluated. For example, the sample data pair in operation S510 may be determined based on the target data and the response result to be evaluated in the data processing method 200. For brevity, detailed descriptions are omitted here.

In embodiments of the present disclosure, the sample data pair may also be determined as follows: in response to determining that the at least one evaluation result indicates a presence of at least one response result to be corrected among the at least one response result to be evaluated, at least one correction data for at least one data synthesis expert unit is determined according to at least one evaluation result for the at least one response result to be corrected; the process returns to the operation of generating at least one response result to be evaluated using at least one of the plurality of data synthesis expert units until the at least one evaluation result indicates an absence of any response result to be corrected among the at least one response result to be evaluated, where the data synthesis expert unit is configured to generate a response result to be evaluated according to at least one of the target data and the received correction data.

According to embodiments of the present disclosure, through a series of operations such as filtering, synthesis, and correction of the target data performed using a plurality of expert large models, diverse and accurate sample data pairs may be obtained, and a model may be trained according to the sample data, so that diverse high-quality sample data pairs with balanced distribution may be obtained, facilitating rapid iteration of the model and improving the generalization ability of the model.

FIG. 6 shows a flowchart of a data processing method according to an embodiment of the present disclosure.

As shown in FIG. 6, a data processing method 600 includes operation S610.

In operation S610, data to be processed is input into a target model to obtain a response result corresponding to the data to be processed.

The target model may refer to a model obtained by training a model to be trained using sample data pairs based on the method 500 described above. When the data to be processed is input into the target model, accurate, diverse, and high-quality response results may be obtained.

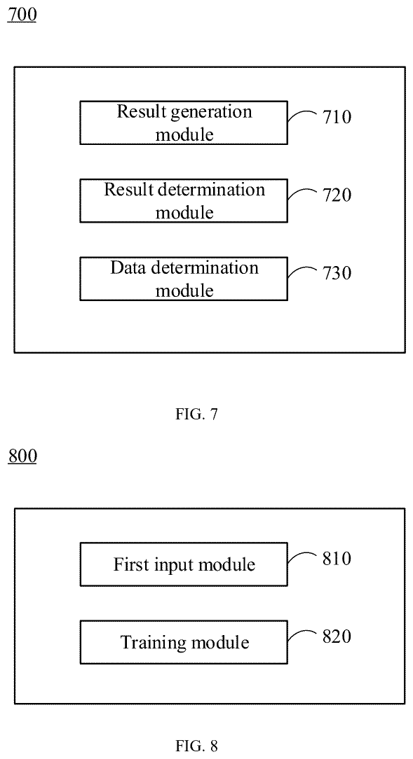

FIG. 7 shows a block diagram of a data generation apparatus according to an embodiment of the present disclosure.

As shown in FIG. 7, a data generation apparatus 700 may include a result generation module 710, a result determination module 720, and a data determination module 730.

The result generation module 710 is configured to generate at least one response result to be evaluated using at least one of a plurality of data synthesis expert units.

The result determination module 720 is configured to determine at least one evaluation result for the at least one response result to be evaluated using at least one of the plurality of data synthesis expert units.

The data determination module 730 is configured to, in response to determining that the at least one evaluation result indicates a presence of at least one response result to be corrected among the at least one response result to be evaluated, determine at least one correction data for at least one data synthesis expert unit according to at least one evaluation result for the at least one response result to be corrected, and return the process to the operation of generating at least one response result to be evaluated using at least one of the plurality of data synthesis expert units, where the data synthesis expert unit is configured to generate a response result to be evaluated according to at least one of target data and received correction data.

According to embodiments of the present disclosure, the data generation apparatus 700 further includes a preprocessing module. The preprocessing module is configured to preprocess a plurality of initial data to obtain at least one target data, where the target data has at least one label.

According to embodiments of the present disclosure, the preprocessing module includes a filtering sub-module and a labeling sub-module. The filtering sub-module is configured to filter the plurality of initial data according to a preset filtering rule to obtain at least one intermediate data. The labeling sub-module is configured to label the at least one intermediate data to obtain at least one target data.

According to embodiments of the present disclosure, the result generation module 710 includes a sub-problem determination sub-module. The sub-problem determination sub-module is configured to generate at least one response result to be evaluated using at least one of the plurality of data synthesis expert units based on at least one sub-problem to be processed determined from a data understanding result. The data understanding result is obtained according to at least one of the target data and an instruction to be processed, and the instruction to be processed is obtained according to the target data.

According to embodiments of the present disclosure, the data understanding result is obtained using a problem understanding expert unit according to the target data.

According to embodiments of the present disclosure, the data understanding result is obtained using a problem understanding expert unit according to an instruction to be processed, and the instruction to be processed is obtained using an instruction synthesis expert unit according to the target data.

According to embodiments of the present disclosure, the sub-problem determination sub-module includes a decomposition unit and a generation unit. The decomposition unit is configured to determine at least one sub-problem to be processed using a step decomposition expert unit according to the data understanding result. The generation unit is configured to generate at least one response result to be evaluated using at least one of the plurality of data synthesis expert units based on the at least one sub-problem to be processed.

According to embodiments of the present disclosure, the result determination module 720 includes an intermediate evaluation sub-module and an evaluation result determination sub-module. The intermediate evaluation sub-module is configured to determine N intermediate evaluation data for an intermediate result to be evaluated using N data synthesis expert units. The intermediate result to be evaluated is obtained by masking an identification information in a response result to be evaluated, the identification information in the response result to be evaluated is associated with the data synthesis expert unit that generated the response result to be evaluated, and N is an integer greater than or equal to 1. The evaluation result determination sub-module is configured to determine an evaluation result for the response result to be evaluated according to the N intermediate evaluation data for the intermediate result to be evaluated.

According to embodiments of the present disclosure, the evaluation result includes at least one evaluation metric value, and the at least one evaluation metric value includes at least one of a first evaluation metric value and a second evaluation metric value. The data generation apparatus 700 further includes a first correction determination sub-module and a second correction determination sub-module. The first correction determination sub-module is configured to, in response to determining that a plurality of evaluation metric values for the response result to be evaluated meet at least one preset evaluation condition, determine that the response result to be evaluated is not a response result to be corrected. The second correction determination sub-module is configured to, in response to determining that the plurality of evaluation metric values for the response result to be evaluated fail to meet one or more of the at least one preset evaluation condition, determine that the response result to be evaluated is a response result to be corrected. The at least one preset evaluation condition includes at least one selected from: the first evaluation metric value is greater than or equal to a first evaluation threshold; and the second evaluation metric value is less than or equal to a second evaluation threshold.

According to embodiments of the present disclosure, the data generation apparatus 700 further includes a sample determination module, which is configured to determine a sample data pair according to the target data and a target response result among the at least one response result to be evaluated, in response to determining that the at least one evaluation result indicates an absence of any response result to be corrected among the at least one response result to be evaluated.

According to embodiments of the present disclosure, the sample determination module includes a response result determination sub-module and a sample determination sub-module. The response result determination sub-module is configured to determine a target response result from the at least one response result to be evaluated. The sample determination sub-module is configured to determine a sample data pair in response to determining that the target response result meets at least one preset data generation condition. The sample data pair includes the target response result and at least one selected from the target data and the instruction to be processed obtained from the target data. The at least one preset data generation condition includes that the data format of the target response result is a preset data format.

According to embodiments of the present disclosure, the data synthesis expert unit is configured to generate a response result to be evaluated according to at least one selected from: the at least one label, the target data, and the received correction data.

According to embodiments of the present disclosure, the data synthesis expert unit is a data synthesis large model or a data synthesis agent.

According to embodiments of the present disclosure, the target data includes at least one selected from: target text data, target audio data, target image data, and target video data.

FIG. 8 shows a block diagram of a model training apparatus according to an embodiment of the present disclosure.

As shown in FIG. 8, the model training apparatus 800 may include a first input module 810 and a training module 820.

The first input module 810 is configured to input target data in a sample data pair into a model to be trained, to obtain a response result to be optimized.

The training module 820 is configured to train the model to be trained according to the response result to be optimized and a target response result in the sample data pair.

According to embodiments of the present disclosure, with reference to FIG. 7 and FIG. 8, the sample data pair is determined by the result generation module 710, the result determination module 720, and the data determination module 730 in the data generation apparatus 700. Specifically, at least one response result to be evaluated is generated using at least one of a plurality of data synthesis expert units, where the data synthesis expert unit is configured to generate a response result to be evaluated according to target data; at least one evaluation result for the at least one response result to be evaluated is generated using at least one of the plurality of data synthesis expert units; in response to determining that the at least one evaluation result indicates an absence of any response result to be corrected among the at least one response result to be evaluated, the sample data pair is determined according to the target data and a target response result among the at least one response result to be evaluated.

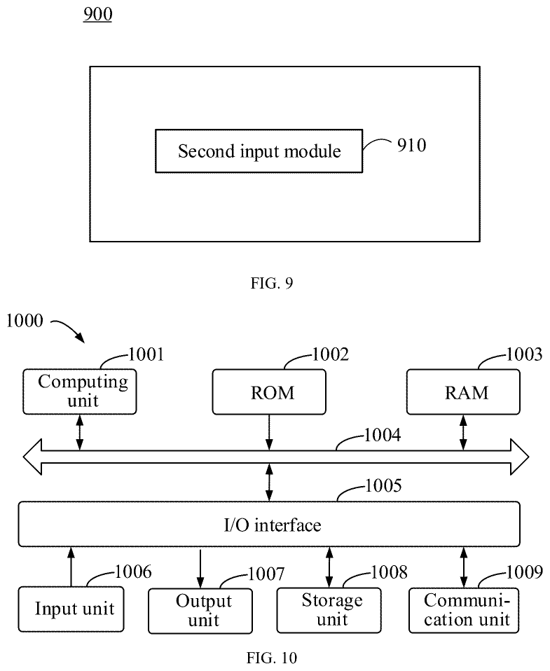

FIG. 9 shows a block diagram of a data processing apparatus according to an embodiment of the present disclosure.

As shown in FIG. 9, the data processing apparatus 900 includes a second input module 910.

The second input module 910 is configured to input data to be processed into a target model to obtain a response result corresponding to the data to be processed, where the target model is obtained by training a model to be trained using the apparatus described in embodiments of the present disclosure.

In the technical solutions of the present disclosure, the collection, storage, use, processing, transmission, provision, and disclosure of user personal information involved all comply with relevant laws and regulations and do not violate public order and good customs.

According to embodiments of the present disclosure, the present disclosure further provides an electronic device, a readable storage medium, and a computer program product.

FIG. 10 shows a schematic block diagram of an example electronic device 1000 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read-only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graph processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the data generation method, the model training method, and the data processing method. For example, in some embodiments, the data generation method, the model training method, and the data processing method may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the data generation method, the model training method, and the data processing method described above. Alternatively, in other embodiments, the computing unit 1001 may be used to perform the data generation method, the model training method, and the data processing method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data generation method, the model training method, and the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a cathode ray tube (CRT) display or a liquid crystal display (LCD)) for displaying information to users, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A data generation method, comprising:
generating at least one response result to be evaluated using at least one of a plurality of data synthesis expert units;
determining at least one evaluation result for the at least one response result to be evaluated using at least one of the plurality of data synthesis expert units;
in response to determining that the at least one evaluation result indicates a presence of at least one response result to be corrected among the at least one response result to be evaluated, determining at least one correction data for at least one data synthesis expert unit according to at least one evaluation result for the at least one response result to be corrected; and
returning a process to generating at least one response result to be evaluated using at least one of the plurality of data synthesis expert units until the at least one evaluation result indicates an absence of any response result to be corrected among the at least one response result to be evaluated, wherein the data synthesis expert unit is configured to generate a response result to be evaluated according to at least one of target data and received correction data.

2. The method of claim 1, further comprising:
preprocessing a plurality of initial data to obtain at least one target data, wherein the at least one target data has at least one label.

3. The method of claim 2, wherein the preprocessing a plurality of initial data to obtain at least one target data comprises:
filtering the plurality of initial data according to a preset filtering rule to obtain at least one intermediate data; and
labeling the at least one intermediate data to obtain the at least one target data.

4. The method of claim 1, wherein the generating at least one response result to be evaluated using at least one of a plurality of data synthesis expert units comprises:
generating the at least one response result to be evaluated using at least one of the plurality of data synthesis expert units based on at least one sub-problem to be processed determined from a data understanding result, wherein the data understanding result is obtained according to at least one of the target data and an instruction to be processed, and the instruction to be processed is obtained according to the target data.

5. The method of claim 4, wherein the data understanding result is obtained using a problem understanding expert unit according to the target data.

6. The method of claim 4, wherein the data understanding result is obtained using a problem understanding expert unit according to the instruction to be processed, and the instruction to be processed is obtained using an instruction synthesis expert unit according to the target data.

7. The method of claim 4, wherein the generating the at least one response result to be evaluated using at least one of the plurality of data synthesis expert units based on at least one sub-problem to be processed determined from a data understanding result comprises:
determining the at least one sub-problem to be processed using a step decomposition expert unit according to the data understanding result; and
generating the at least one response result to be evaluated using at least one of the plurality of data synthesis expert units based on the at least one sub-problem to be processed.

8. The method of claim 1, wherein the determining at least one evaluation result for the at least one response result to be evaluated using at least one of the plurality of data synthesis expert units comprises:
determining N intermediate evaluation data for an intermediate result to be evaluated using N data synthesis expert units, wherein the intermediate result to be evaluated is obtained by masking an identification information in a response result to be evaluated, the identification information in the response result to be evaluated is associated with the data synthesis expert unit that generated the response result to be evaluated, and N is an integer greater than or equal to 1; and
determining an evaluation result for the response result to be evaluated according to the N intermediate evaluation data for the intermediate result to be evaluated.

9. The method of claim 1, wherein the evaluation result comprises at least one evaluation metric value, and the at least one evaluation metric value comprises at least one of a first evaluation metric value and a second evaluation metric value, the method further comprising:
in response to determining that a plurality of evaluation metric values for the response result to be evaluated satisfy at least one preset evaluation condition, determining that the response result to be evaluated is not a response result to be corrected; and
in response to determining that the plurality of evaluation metric values for the response result to be evaluated fail to satisfy one or more of the at least one preset evaluation condition, determining that the response result to be evaluated is a response result to be corrected, wherein the at least one preset evaluation condition comprises at least one selected from:
the first evaluation metric value is greater than or equal to a first evaluation threshold; and
the second evaluation metric value is less than or equal to a second evaluation threshold.

10. The method of claim 1, further comprising:
in response to determining that the at least one evaluation result indicates an absence of any response result to be corrected among the at least one response result to be evaluated, determining a sample data pair according to the target data and a target response result among the at least one response result to be evaluated.

11. The method of claim 10, wherein the determining a sample data pair according to the target data and a target response result among the at least one response result to be evaluated comprises:
determining the target response result from the at least one response result to be evaluated; and
determining the sample data pair in response to determining that the target response result satisfies at least one preset data generation condition, wherein the sample data pair comprises the target response result and at least one of the target data and an instruction to be processed obtained from the target data, and the at least one preset data generation condition comprises that a data format of the target response result is a preset data format.

12. The method of claim 2, wherein the data synthesis expert unit is configured to generate a response result to be evaluated according to at least one selected from: the at least one label, the target data, and the received correction data.

13. The method of claim 1, wherein the data synthesis expert unit is a data synthesis large model or a data synthesis agent, and the returning to generating at least one response result to be evaluated using at least one of the plurality of data synthesis expert units until the at least one evaluation result indicates an absence of any response result to be corrected among the at least one response result to be evaluated comprises:
returning the process to generating at least one response result to be evaluated using at least one of the plurality of data synthesis expert units until at least one subsequently determined evaluation result indicates an absence of any response result to be corrected among the at least one response result to be evaluated.

14. The method of claim 1, wherein the target data comprises at least one selected from: target text data, target audio data, target image data, and target video data.

15. A model training method, comprising:
inputting target data in a sample data pair into a model to be trained, to obtain a response result to be optimized; and
training the model to be trained according to the response result to be optimized and a target response result in the sample data pair, wherein the sample data pair is determined by:
generating at least one response result to be evaluated using at least one of a plurality of data synthesis expert units, wherein the data synthesis expert unit is configured to generate a response result to be evaluated according to the target data;
determining at least one evaluation result for the at least one response result to be evaluated using at least one of the plurality of data synthesis expert units; and
in response to determining that the at least one evaluation result indicates an absence of any response result to be corrected among the at least one response result to be evaluated, determining the sample data pair according to the target data and a target response result among the at least one response result to be evaluated.

16. A data processing method, comprising:
inputting data to be processed into a target model to obtain a response result corresponding to the data to be processed, wherein the target model is obtained by performing operations of:
inputting target data in a sample data pair into a model to be trained, to obtain a response result to be optimized; and
training the model to be trained according to the response result to be optimized and a target response result in the sample data pair, wherein the sample data pair is determined by:
generating at least one response result to be evaluated using at least one of a plurality of data synthesis expert units, wherein the data synthesis expert unit is configured to generate a response result to be evaluated according to the target data;
determining at least one evaluation result for the at least one response result to be evaluated using at least one of the plurality of data synthesis expert units; and
in response to determining that the at least one evaluation result indicates an absence of any response result to be corrected among the at least one response result to be evaluated, determining the sample data pair according to the target data and a target response result among the at least one response result to be evaluated.

17. An electronic device, comprising:
at least one processor; and
a memory communicatively connected to the at least one processor, wherein the memory stores instructions executable by the at least one processor, and the instructions are configured to, when executed by the at least one processor, cause the at least one processor to perform the method of claim 1.

18. An electronic device, comprising:
at least one processor; and
a memory communicatively connected to the at least one processor, wherein the memory stores instructions executable by the at least one processor, and the instructions are configured to, when executed by the at least one processor, cause the at least one processor to perform the method of claim 15.

19. An electronic device, comprising:
at least one processor; and
a memory communicatively connected to the at least one processor, wherein the memory stores instructions executable by the at least one processor, and the instructions are configured to, when executed by the at least one processor, cause the at least one processor to perform the method of claim 16.

20. A non-transitory computer-readable storage medium storing computer instructions, wherein the computer instructions, when executed by a processor, are configured to, when executed by a computer, cause the computer to perform the method of claim 1.
